(19) United States
(12) Patent Application Publication
(10) Pub. No.: US 2023/0148785 A1
(43) Pub. Date: May 18, 2023

(54) Tea Bag Device for use with a Beverage Container Having a Lid

(71) Applicants: W. Grover Coors, Golden, CO (US); Thomas Waller, Redlands, CA (US)

(72) Inventors: W. Grover Coors, Golden, CO (US); Thomas Waller, Redlands, CA (US)

(21) Appl. No.: 17/530,061

(22) Filed: Nov. 18, 2021

(51) Int. Cl. A47J 31/20; B65D 51/28; B65D 85/808; A47J 31/00; A47J 31/06; A47J 31/44; A23F 3/18

(52) U.S. Cl. CPC A47J 31/20; B65D 51/28; B65D 85/808; A47J 31/005; A47J 31/0636; A47J 31/4407; A23F 3/18

(57) ABSTRACT

A tea bag device is described which is for use with a beverage container having a lid. Method of forming a beverage container containing the tea bag device and for steeping tea are also provided. The tea bag device includes (a) a tea bag enclosing a volume of tea and (b) a snap-fit attachment comprising male and female snap portions. The snap-fit attachment is configured so that when the male and female portions are reversibly engaged with each other, and the snap-fit attachment is engaged with the tea bag and the lid the tea bag is biased against an undersurface of the lid.

### TECHNICAL FIELD

Tea bag devices as disclosed herein are constructed for use in making beverages or the like and, more particularly, are specially configured for use in making beverages within a drinking container having a lid and including a volume of liquid within which a portion of device is disposed to infuse a material in the device with the liquid in the drinking container.

### BACKGROUND OF THE INVENTION

Many types of hot beverages are prepared by brewing an organic ingredient such as tea, coffee, herbs and the like, in hot water. Taste and aroma of the beverage are enhanced by steeping, which involves keeping the organic ingredient in direct contact with hot water for a prescribed period of time. Prior to drinking the resulting liquid, the organic matter must be filtered or strained out. One common way to do this is to encapsulate the organic matter in and infuser device such that permits hot water to percolate freely to the inside but prevents the organic matter from escaping to bulk liquid on the outside by use of a porous filter such as a metal screen or fabric straining filter. A tea bag is one example of such an infuser device.

In order to properly prepare tea made from, e.g., loose leaf tea, it is necessary to steep the leaves in hot water for a prescribed period of time. Prolonged steeping can damage the taste and aroma of the beverage, typically resulting in bitter taste. As a consequence, loose leaf tea is typically placed in a basket strainer, called an infuser, that is left immersed in the hot water for a period of time, and then removed prior to drinking. A common feature of all infusers used in the past is that some provision has been made to remove the infuser from the brewed liquid prior to consumption. However, the added inconvenience of removing the infuser from the drinking container and then disposing it afterwards has tended to dis-incentivize hot tea drinking, as opposed to iced-tea or coffee drinking, where the infuser is not part of the final processes. Tea bags and tea balls have long been used as infusers intended to be removed from the drinking container or cup when steeping is complete. Additionally, as noted above, leaving such infuser within the drinking container and in contact with liquid leads to oversteeping resulting in the beverage eventually having a bitter or unpleasant taste. Therefore, most infusers used with loose leaf tea are intended to be removed from the cup prior to consumption.

Accordingly, in view of the above, it is desired that an infuser tea-bag device be constructed in a manner capable of enabling a desired material to be infused for purposes of making a beverage, while also reducing or eliminating the possibility of oversteeping. It is also desired that such infuser device be constructed in a manner that may be easily removed from the hot liquid if desired or provides this function without requiring the user to remove it from the drinking container by virtue of having the level of hot liquid fall below the bottom of the infuser after partial consumption. It is further desired that such device also be constructed in a manner that permits its use with common drinking containers having removable lids, wherein such drinking containers may be in the form of disposable containers (e.g. such as those sold under the Solo brand name) or reusable drinking containers such as motion mugs and the like use for transporting hot beverage contents and that are specifically configured to prevent or minimize spilling of the container contents during transportation and/or use. It is further desired that such a device be easily used and be compliant across tea bags having many different selections of infusant tea flavors.

### BRIEF SUMMARY OF THE INVENTION

The present invention provides solutions to the above-described problems in the art. In a first embodiment the present invention provides a tea bag device for use with a beverage container having a lid. The device includes (a) a tea bag enclosing a volume of tea infusant and (b) a snap-fit attachment comprising male and female snap portions, wherein the snap-fit attachment is configured such that when the male and female portions are reversibly engaged with each other and the snap-fit attachment is engaged with the tea bag and the lid the tea bag is biased against an undersurface of the lid.

In a second embodiment, a beverage container is provided which includes a lid and the tea bag device described above. The male and female portion of the snap-fit attachment are reversibly engaged with each other and the snap-fit attachment is engaged with the tea bag and the lid such that the tea bag is biased against the undersurface of the lid.

In a third embodiment, a method of attaching a tea bag to a lid of a disposable beverage container is provided. Alternatively, a method of forming the beverage container described above is also provided. In either event the associated method includes the steps of: providing the tea bag device described above; and reversibly engaging the snap-fit attachment with the tea bag and the lid; wherein when attached, the tea bag is biased against the underside of the lid.

In a fourth embodiment the present invention provides a method of steeping tea. The method is inclusive of the steps of: (a) forming the beverage container described above, and (b) contacting the tea bag with hot water disposed in the beverage container for a predetermined period of time.

### BRIEF DESCRIPTION OF THE DRAWINGS

Advantages of embodiments of the tea bag devices, apparatuses and methods as disclosed herein will be apparent from the following detailed description of the exemplary embodiments, which detailed description should be considered in conjunction with the accompanying figures.

FIG. 1 shows an exploded view of a tea bag device and a beverage container employing the tea bag devices according to embodiments of the present invention.

FIGS. 2A to 2C show side, top and bottom elevation views of a beverage container lid engaged with a tea bag device according to embodiments of the present invention.

FIG. 3. Shows preferred configurations of the snap-fit attachment according to embodiments of the present invention.

### DETAILED DESCRIPTION OF THE INVENTION:

Teabag devices and constructions as disclosed herein are specifically designed to accommodate a volume of infusate material, such as tea, coffee, herbs and the like, and are for contact with infusion of a liquid that is disposed within a beverage container having a lid (such as a disposable or reusable beverage container). The teabag device, and in particular the snap-fit attachment device are specifically configured so that the tea bag is biased against the underside of the lid and at a fixed position within the container such that when liquid is in the container in a filled state the tea bag is disposed in contact with the water and as the liquid is reduced or consumed the liquid level moves away from and out of contact with such material to reduce or eliminate over steeping and the undesired aroma and taste associate therewith. Such a teabag device and constructs using the device and methods of use thereof as disclosed herein are specifically configured to accommodate attachment with the lid of disposable drinking containers and reusable containers having lids formed from materials such as plastic, wood, metal and the like and are capable of withstanding high liquid temperatures, such as the boiling point of water and the like, for the purposes of carrying out the intended function in a hot-beverage end-use application.

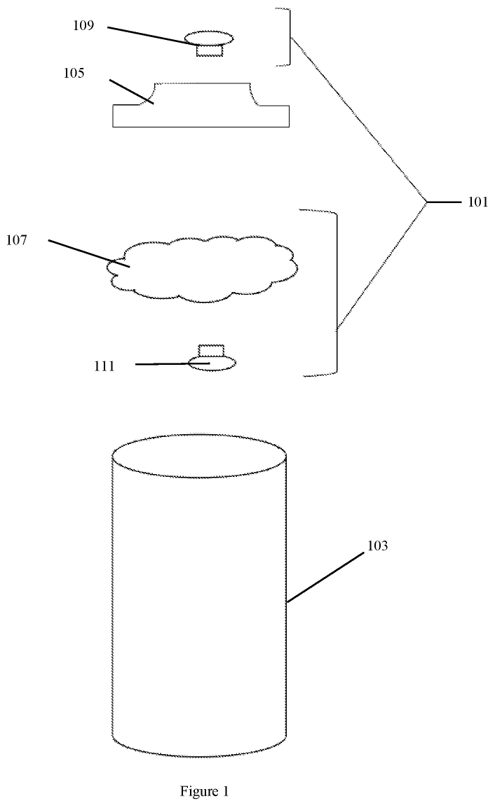

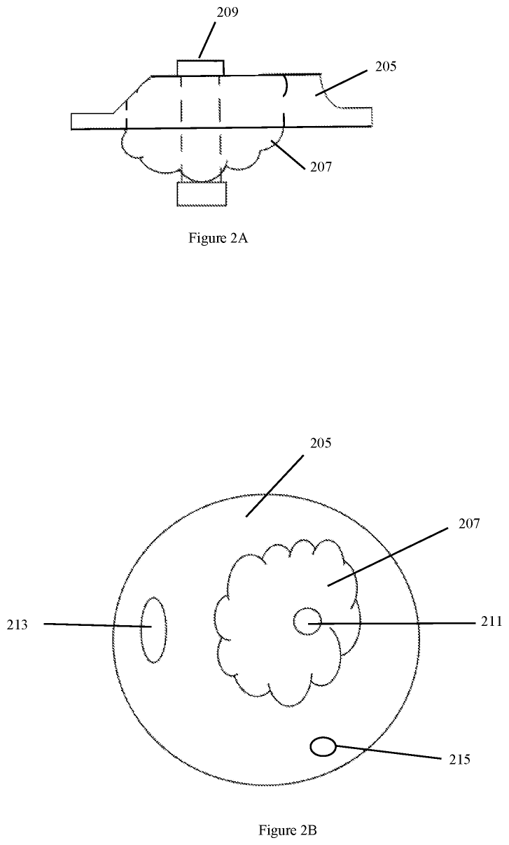

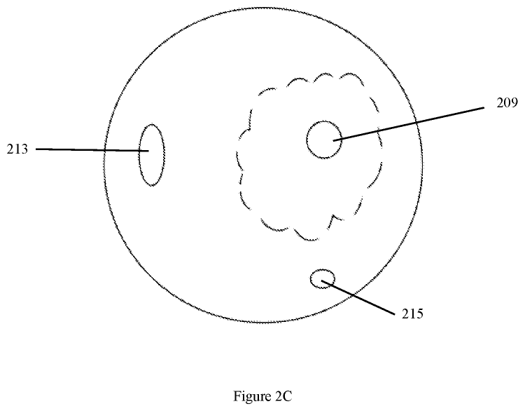

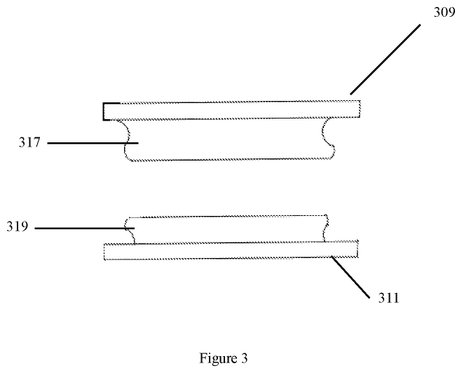

FIG. 1 shows a tea bag device 101 and also a beverage container in an exploded view containing the tea bag device in accordance with preferred embodiments of the present invention. The tea bag device 101 is for use with a beverage container 103 having a lid 105. The lid 105 being complimentary and reversibly engageable with the opening of the container 103 so as to form an enclosed volume for liquid and the tea bag device etc. The tea bag device 101 includes (a) a tea bag 107 enclosing a volume of tea and (b) a snap-fit attachment 109/111 comprising female 109 and male 111 snap-fit portions. The mating snap-fit portion, 109 corresponding to 111 or 111 corresponding to 109, is permanently attached to the lid 105. As show in FIG. 2A and 2B, the female snap-fit attachment 209 is configured such that when the male 211, attached to the tea bag, and female portions 209 are reversibly engaged with each other and the snap-fit attachment is engaged with the tea bag 207 and the lid 205 the tea bag 207 is biased against an undersurface of the lid 205. Note that in other embodiments, the snap-fit attachment portions engagements are reversed where the female portion 209 is attached to the tea bag 207 and the male portion 211 is attached to the lid 205, etc.

The tea bag is not particularly limited and such devices are well known in the art for enclosing a volume of infusate within a porous body to allow exchange of liquid therethrough. Such enclosures can be made of a paper, plastic, or cloth porous body etc.

The material of construction of the snap-fit attachment 109/111 is not particularly limited and can be any type of rigid or semi-rigid material such as plastic, wood, or metal. Since in preferred embodiments, the assemblies are disposable, it is most preferred the material be inexpensive and in some cases made of plastic. Each of the respective portions 109 and 111 may be single pieces of construction or formed from two or more pieces which together form an integral structure when in use etc.

FIGS. 2A through 2C shows additional preferred embodiments of the tea bag device and container assembly of the present invention. As show in the figures in preferred embodiments, the female portion 209 of the snap-fit attachment is configured for engagement with the lid 205 and wherein the male portion 211 of the snap-fit attachment is configured for engagement with the tea bag 207.

In additional preferred embodiments show in these figures, when attached to the lid 205 the snap-fit attachment 209/211 and tea bag 205 are radially offset from the central axis of the lid 205 and container 105 shown in FIG. 1. In such embodiments the tea bag device can be configured to be radially offset from a drinking opening 213 and/or vent 215 resident on the lid 205.

In some embodiments, while at least a portion of tea bag (such as a fabric tea bag) 107 is biased directly against the underside of the lid 105 via the snap-fit attachment means 109/111, it is preferred that the tea bag have enough bulk and/or sag to allow the bag and infusate therein contained to hang away from the underside of the lid 105 via application of gravity so that a portion of the tea bag and infusate therein contained hangs into the container 103 volume such that the infusate material can engage with liquid when contained therein and the lid 105 is reversibly associated with the container 103.

The snap-fit attachment is shown in greater detail in FIG. 3. The female portion 309 contains a female receiver 317 having a volume which is sized and shaped to receive the corresponding male insert 319 of the male portion 311. In preferred embodiments the male and female portions are reversibly engageable with one another without the use of destructive force. In other embodiments, upon engagement of the male and female portions, an audible noise such as a click or can be detected so as to confirm engagement to a user. In other embodiments not pictured, the male female portions of the attachment each may each be formed from at least two or a plurality of parts such that the user can physically couple the corresponding portions with the lid and/or the tea bag prior to reversible engagement of the male and female portions with one another.

The teabag devices of any of the embodiments described above are preferably packaged together in a single packaging for sale to and use by an end user. In this embodiment, the user can retrofit an existing beverage container by coupling the respective portions of the snap-fit attachment with the and tea bag and lid and then reversibly engaging the male and female portions with one another prior to steeping tea. In other embodiments, the respective portion of the snap-fit attachment is already coupled with the tea bag and the user can then couple the other mating portion of the snap-fit attachment separately to/with the lid and then reversibly engage the tea bag with the lid via the male and female portions of the snap-fit attachment. In more preferred embodiments, the packing would further include written instructions or a QR code directing a user to instructions for forming the combinations and steeping tea etc.

In a further preferred embodiment, the present invention provides a fully formed beverage container comprising a lid and the tea bag device described above. In this embodiment, the male 111 and female portion 109 of the snap-fit attachment are reversibly engaged with each other and the snap-fit attachment is engaged with the tea bag 107 and the lid 105 such that the tea bag 105 is biased directly against and in direct contact the undersurface of the lid 105.

In another embodiment, and as shown using FIG. 1, the present invention provides method of attaching the tea bag device 101 as described above to a lid 105 of a disposable beverage container 103. The method is inclusive of the steps of: providing the tea bag device 101 as described in any embodiment above; reversibly engaging the snap-fit attachment 109/111 with the tea bag 107 and the lid 105. When the male 111 and female 109 portions are reversibly engaged with each other and the lid and the tea bag, the tea bag is biased against and/or in direct contact with the underside of the lid.

Again, in preferred embodiments, the female portion 109 of the snap-fit attachment is configured for and engaged with the lid 105 and wherein the male portion 111 of the snap-fit attachment is configured for engagement with the tea bag 107. Alternatively, the male portion 111 of the snap-fit attachment is configured for and engaged with the lid 105 and wherein the female portion 109 of the snap-fit attachment is configured for engagement with the tea bag 107 In such preferred embodiments, the method further includes the step of: disengaging the snap-fit attachment 109/111 after use of the tea bag. In other preferred embodiments, the beverage container, the lid and the tea bag device are disposable and in such embodiments the method preferably further comprises the step of disposing of beverage container after use.

In yet a further embodiment, the present invention provides a method of steeping tea. This preferred method includes the steps of: (a) forming a combination of the beverage and tea bag device as described in any embodiment above wherein the tea bag in biased against and/or in direct contact with the undersurface of the lid; and (b) contacting the tea bag with hot water disposed in the beverage container for a predetermined period of time.

A feature of tea bag devices, combinations of the same with liquid drinking container, and methods of using the same include the ability to position an infusant within a drinking container of liquid in a manner that avoids oversteeping and allows for easy coupling and decoupling of the teabag device from the lid. A further feature of such tea bag device is the ability to easily provide the same as a disposable component along with a disposable liquid drinking container to promote ease of use and disposal. In other embodiments, since the male and female components of snap-fit attachment means are easily coupled and decoupled (engaged/disengaged etc.) with one another, the present invention provides for a further method of reuse of the beverage container by simply swapping out a used teabag for a unused tea bag by disengaging the used tea bag from the lid and the snap-fit attachment and engaging a new tea bag to the lid via the same or a new snap fit attachment means or portions thereof.

The foregoing description and accompanying figures illustrate the principles, preferred embodiments and modes of operation of tea bag devices, beverage containers, and method of forming and using these embodiments. Such devices, embodiments, and description should not be construed as being limited to the particular embodiments discussed above as many additional variations can be and are easily envisioned by the inventors and will be appreciated by those skilled in the art. Therefore, the above-described embodiments should be only regarded as illustrative rather than restrictive. Accordingly, it should be appreciated that variations to those embodiments can be made by those skilled in the art without departing from the scope of infuser devices as defined by the following claims. Any one embodiments or section of the description can be easily combined with any other embodiment or portion of the description to arrive at a combined embodiment which is fully disclosed and envisioned herein.

1. A tea bag device for use with a beverage container having a lid, the device comprising: (a) a tea bag enclosing a volume of tea and (b) a snap-fit attachment comprising male and female snap portions, wherein the snap-fit attachment is configured such that when the male and female portions are reversibly engaged with each other and the snap-fit attachment is engaged with the tea bag and the lid the tea bag is biased against an undersurface of the lid.

2. The device of claim 1, wherein: the female portion of the snap-fit attachment is configured for engagement with the lid and wherein the male portion of the snap-fit attachment is configured for engagement with the tea bag.

3. The device of claim 1, wherein tea bag device is disposable.

4. The device of claim 1, wherein when attached to the lid the snap-fit attachment and tea bag are radially offset from the axis of the lid and container.

5. A beverage container comprising a lid and the tea bag device of claim 1, wherein the male and female portion of the snap-fit attachment are reversibly engaged with each other and the snap-fit attachment is engaged with the tea bag and the lid such that the tea bag is biased against the undersurface of the lid.

6. The container of claim 5, wherein: the female portion of the snap-fit attachment is configured for and engaged with the lid and wherein the male portion of the snap-fit attachment is configured for engagement with the tea bag.

7. The container of claim 5, wherein the beverage container, the lid and the tea bag device are disposable.

8. The container of claim 5, wherein the snap-fit attachment and tea bag are radially offset from the axis of the lid and container.

9. A method of attaching a tea bag to a lid of a disposable beverage container comprising the steps of:
providing the tea bag device of claim 1; and
reversibly engaging the snap-fit attachment with the tea bag and the lid;
wherein when attached, the tea bag is biased against the underside of the lid.

10. The method of claim 9, wherein the female portion of the snap-fit attachment is configured for and engaged with the lid and wherein the male portion of the snap-fit attachment is configured for engagement with the tea bag, wherein the method further includes the step of:
disengaging the snap-fit attachment after use of the tea bag.

11. The method of claim 9, wherein the beverage container, the lid and the tea bag device are disposable and the method further comprises the step of disposing of beverage container after use.

12. The method of claim 5, wherein the snap-fit attachment and tea bag are radially offset from the axis of the lid and container.

13. A method of steeping tea, comprising the steps of:
(a) forming the beverage container of claim 5; and
(b) contacting the tea bag with hot water disposed in the beverage container for a predetermined period of time.

14. The method of claim 13, wherein the female portion of the snap-fit attachment is configured for and engaged with the lid and wherein the male portion of the snap-fit attachment is configured for engagement with the tea bag, wherein the method further includes the step of:
disengaging the snap-fit attachment after use of the tea bag.

15. The method of claim 13, wherein the beverage container, the lid and the tea bag device are disposable and the method further comprises the step of disposing of beverage container after use.

16. The method of claim 13, wherein the snap-fit attachment and tea bag are radially offset from the axis of the lid and container.
